(19) United States
(12) Patent Application Publication
(10) Pub. No.: US 2010/0199586 A1
(43) Pub. Date: Aug. 12, 2010

(54) Insulation system for cement walls

(76) Inventor: Julien Martineau, Gatineau (CA)

Correspondence Address: Julien Martineau, 1704 Arthur Fecteau, Gatineau, QC, J8R3T4, CA

(21) Appl. No.: 12/387,063

(22) Filed: Apr. 28, 2009

(30) Foreign Application Priority Data
Feb. 12, 2009 (CA) 2,652,839

(51) Int. Cl. E04B 2/00; E04B 2/64; F16B 5/06; E04B 2/56

(52) U.S. Cl. 52/506.05; 411/522; 52/656.1

(57) ABSTRACT

This invention relates to a building wall construction comprising of an already existing cement wall, plastic insulating panels, c-shaped fasteners and an interior framework composed of vertical studs and/or beams. The exterior faces of the panels are placed adjacent to the interior face of the cement wall. The insulating panels are comprised of equally spaced vertical channels along its length. Fasteners are placed inside the vertical channels and are used as the connecting element between the panels and the cement wall. The exterior faces of the studs or beams are then placed adjacent to the interior face of the fasteners. By having insulating panels between the fasteners and the studs or beams, this assures that no thermal bridge is created, thus better insulating the living space. The vertical channels allow for the fasteners and studs to be tightly nestled inside the insulating panels.

### FIELD OF THE INVENTION

This invention relates to fasteners and the building construction of a wall composed of insulating panels, an already existing cement wall and interior frame work.

### BACKGROUND OF THE INVENTION

In the pouring of concrete walls, such as for example foundation walls, what is typically done is to pour concrete footings on a suitable bed of gravel or the like. These footings extend upward to the level where the floor of the basement (or first story, if there is no basement) will be. Two opposed forms are then erected which define between them a cavity into which concrete is poured. The forms are typically of metal or wood, and are of standard size. Typically, the forms forming opposite faces of the cavity are joined together with pins (sometimes known as “ties”) of metal or plastic. The ties are left in the concrete after it is poured and form part of the wall.

It is also known in that art, as a common building technique to construct an interior support frame that would attach itself to the existing cement wall. This would allow the completion of the basement, or first floor, by connecting any type of wall to the interior side of the frame. Typically, the support frame is made of wood studs and beams but can be made of other materials such as steel. It is common place to use metal connectors to connect the wood frame to the cement wall. These connectors may be screws, bolts, clips, etc.

In areas where colder climates reside, it is also known to build forms of blocks of plastic insulation which define the cavity into which the concrete is poured. The insulation is usually expanded polystyrene, although other types of plastic insulation may be used. The plastic foam is left in place after the concrete is poured to function as insulation.

There are other systems that exist that meet the needs described above by insulating the walls of a residential home. One representative is shown in the Canadian Patent 2461501 (Schilger). In this specific patent, the inventor connects insulating panels to an already existing frame using metal or plastic connectors. The exterior wall is then placed after, along the exterior face of the insulating plastic panels. The foam panel as described in this patent is placed along the exterior face of the frame.

Another known technique of insulating a cement wall in areas where that is needed is to place the insulating panels between the studs of the existing frame. It is possible to glue pieces of wood to the foam panel and then to screw the foam panel directly into the already existing cement wall. A similar but more economical option would be to blow fiber glass wool between the studs and beams of the existing frame structure.

The Canadian Patent 2461501 does in fact provide an adequate solution when wanting to insulate the wall of a residential home. However, this solution is not adequate if the cement wall is already in place. According to this specific patent, the frame structure must already be built and the foam panels are placed behind it. The exterior wall must then be placed after the plastic insulation is connected to the frame structure.

It also may be desirable to place insulating panels directly on top of the already existing cement wall and between the already existing wood studs. Still, this allows for a thermal bridge to be created between the cement wall and the interior finished wall. In this situation, there are no insulating panels between the wood studs and the cement wall, thus allowing the warm air of the heated room to escape. Even if the foam panels were to be placed between the frame structure and the cement wall, the thermal bridge would still be created along the metal connectors placed between the foam/wood frame and the cement wall. Furthermore, if fiber glass wool is used instead of foam panels between the already existing studs or beams, this would still not solve the problem of the thermal bridge created between the studs or beams of the interior framework and the cement wall. Not to mention the facts that in the case of foundation cement walls, it is not possible to blow wool all the way down to the floor of the foundation because of the humidity and moisture that the wool would absorb.

It is an object of the present invention to provide a thermally non-conducting connection as well as a fast and easy technique of construction, to attach plastic insulating panels as well as a wood frame structure to an already existing cement wall.

### Invention

This invention, in its broadest form, relates to fasteners and the building construction of a wall composed of insulating panels, an already existing cement wall and interior framework. The interior framework is composed of a plurality of studs and beams. The exterior face of the insulating foam panel is placed adjacent to the interior face of the already existing cement wall. The exterior face of the c-shaped fastener is then placed adjacent to the interior face of the vertical channels of the insulating panels. Finally, the exterior face of the studs or beams of the interior framework are then placed adjacent to the interior face of the c-shaped fastener.

Pluralities of vertical channels are formed in the plastic insulating panels. The c-shaped fasteners are firmly placed inside these vertical channels. It is through these fasteners that the plastic insulating panels will connect itself unto the already existing cement wall. Once the fasteners are tightly fitted inside the vertical channels, an automatic sealing pistol is used to firmly connect the insulating panel to the cement wall. The nail used along with the automatic sealing pistol will connect all 3 elements together, the fastener, the plastic insulating panel and the cement wall.

The interior framework of the wall is snuggly placed inside the vertical channels provided by the plastic insulating panels. The vertical channels of the plastic insulating panels along with the fastener create a shell in which the studs or beams of the interior framework will be placed.

In a preferred embodiment, the vertical channels of the insulating panels will not have the same thickness as the fastener or the studs of the interior framework. Both the fastener and the studs of the interior framework will be longer along the thickness of the vertical channel. The space provided between the interior face of the plastic insulating panels and the interior face of the stud of the interior framework, will allow the proper installation of electrical wires and the completion of the living space of the basement via installation of an interior wall.

In a further embodiment, the studs of the interior framework will be firmly connected to the metal fasteners. This can be done using screws that will go threw each side of the interior framework as well as the sides of the fastener that are not within the vertical channels of the plastic insulating panel. To that effect, the fasteners will be comprised of screw holes along the sides of the fasteners to accommodate the screws that will pass through the studs. In this embodiment, the studs will be firmly attached to the fasteners not allowing any movement of the interior framework when installing the inner wall of the living space.

In a further embodiment, the fasteners used with this method are made of metal; ensuring that the fastener will not brake upon the application of the force that the automatic sealing pistol will induce. However, the fastener can be made of other materials assuming that this material will withstand the impact force the automatic sealing pistol will induce on it.

By placing a plastic insulating panel between the already existing cement wall and the fastener, this ensures a thermally non-conducting connection between the cement wall and the fastener. Furthermore, the vertical channels permit a snug fit of the fasteners with the plastic insulating panel and the studs or beams of the interior framework. Additionally, the vertical channels and the building construction of the wall ensure a maximization of space of the living space of the basement. Finally, the vertical channels provided by the plastic insulating panels as well as the fasteners as described in the preferred embodiments above allow a fast and easy installation of the plastic insulating panels and the interior framework to an already existing cement wall.

A preferred embodiment of the invention will now be described with reference to the drawings in which like features of the invention bear like reference numerals throughout the several figures of the drawings.

### BRIEF DESCRIPTION OF THE DRAWINGS

FIG. 1 is an isometric view of a wall construction according to the invention.

FIGS. 2 and 2A are detailed isometric views of wall construction according to the invention.

FIG. 3 is an isometric view of the preferred embodiment of the c-fastener used in the wall construction according to the invention.

FIG. 4 is a top view of the preferred embodiment of the c-fastener typically used in the wall construction according to the invention.

FIG. 5 is an isometric view of the plastic insulating panel along with a vertical channel according to the invention.

FIG. 6 is a perspective view of an embodiment of the c-shaped fastener that does not include the screw holes in the sides flanges used to connect the studs to the fastener.

FIG. 7 is a perspective view of an embodiment of the c-shaped fastener that does not include the nail hole that the nail of the automatic sealing pistol will go threw to connect the insulating panel to the cement wall.

FIG. 8 is a perspective view of an embodiment of the c-shaped fastener that is void of any screw or nail holes threw any of its faces.

FIG. 9 is an isometric view of an embodiment of the c-shaped fastener that has the edges of the side flanges open to a certain degree.

FIG. 10 is a frontal view of an embodiment of the c-shaped fastener that has the edges of the side flanges open to a certain degree.

### DETAILED DESCRIPTION OF THE INVENTION DESCRIBED BY THE FIGURES

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

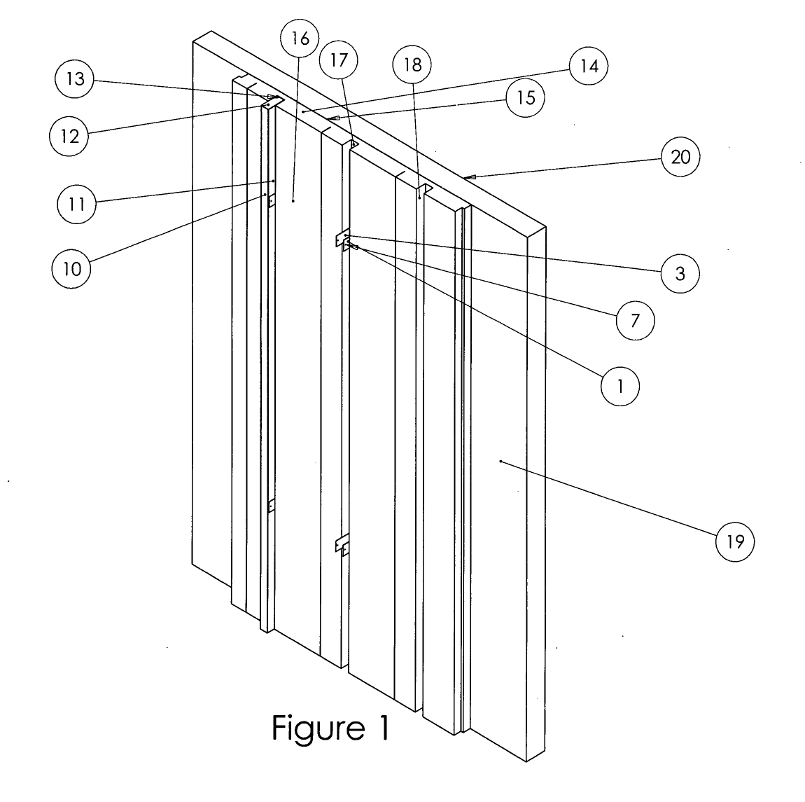

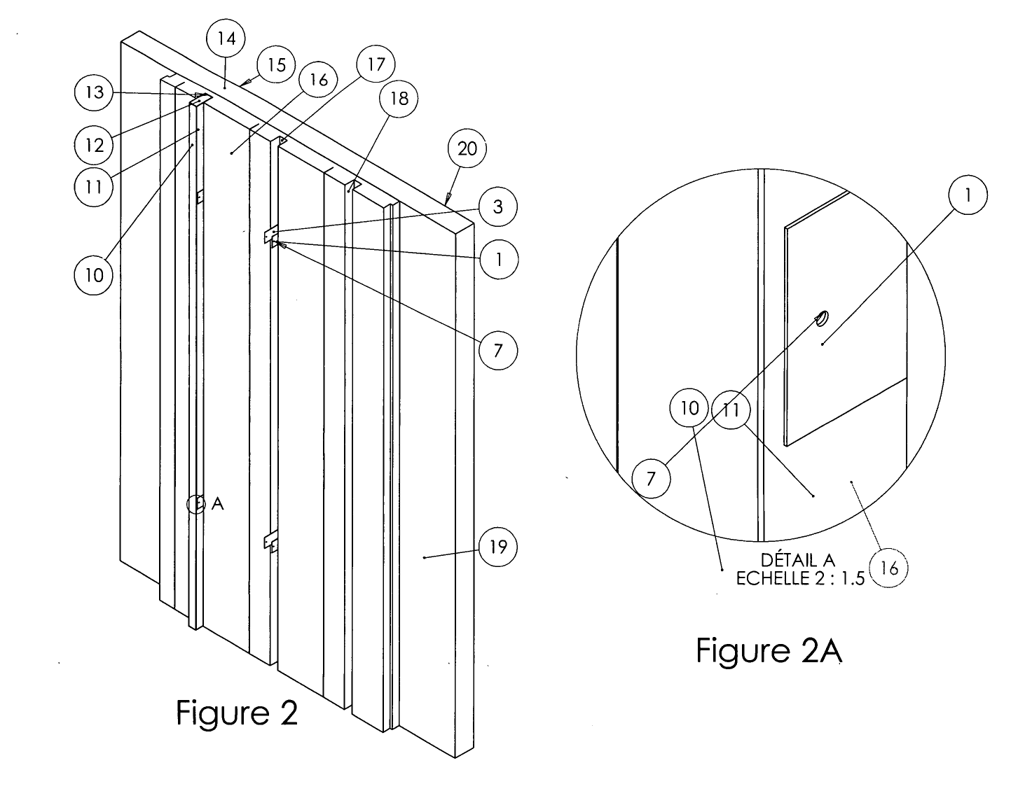

As seen in the FIGS. 1, 2 and 2A, this construction according to the present invention includes a cement wall, a plastic insulating panel with pluralities of channels, a c-shaped fastener and an interior framework formed of rectangular studs.

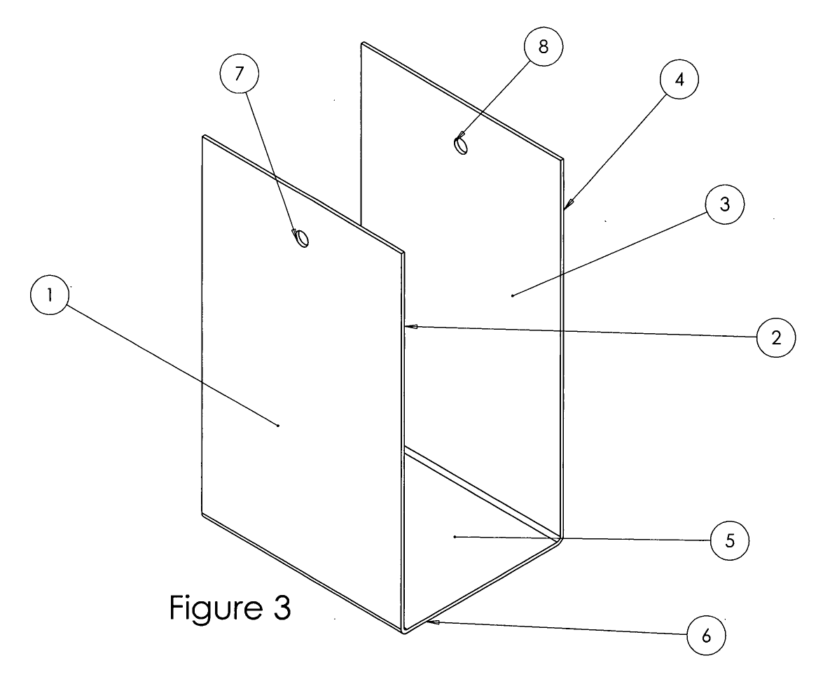

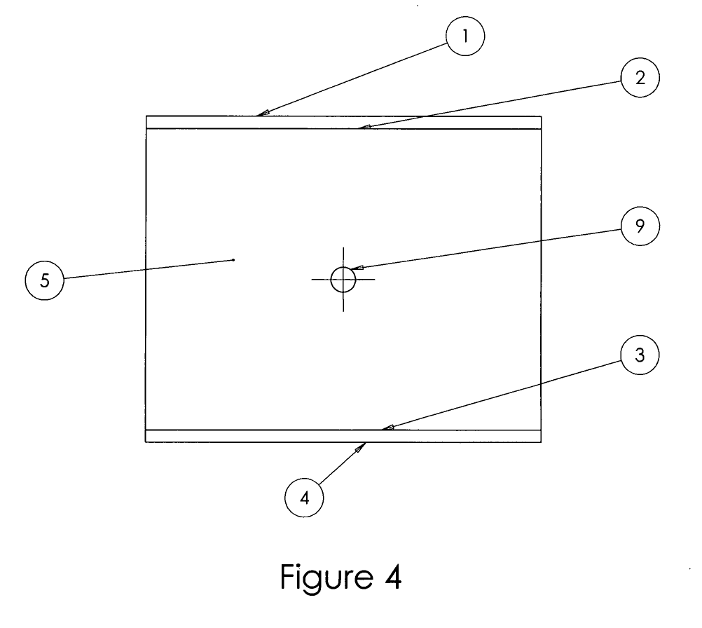

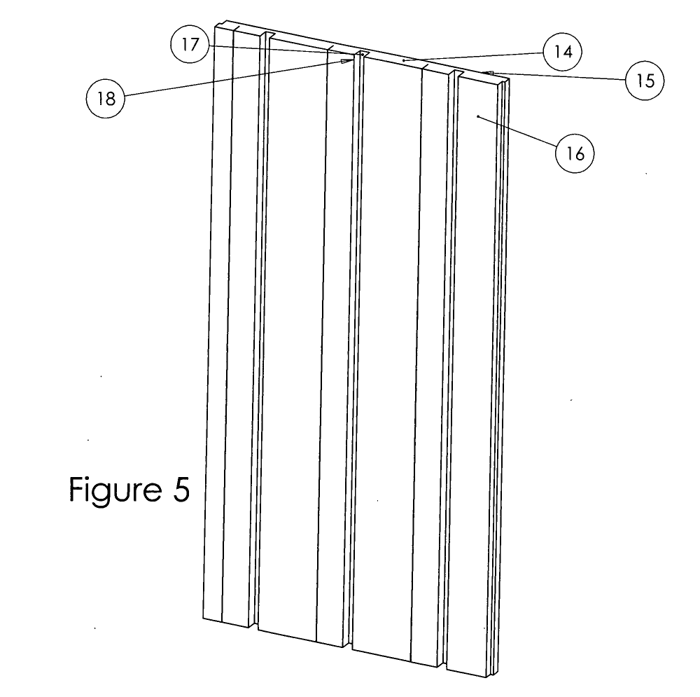

The exterior face of the insulating panels (15) is placed along the interior face of the already existing cement wall (19). Pluralities of fasteners are then placed inside the vertical channels of the plastic insulating panels. According to FIGS. 3 and 5, it is the exterior face of the fastener (6) that will place itself inside the vertical channels of the plastic insulating panel (17). As was described above, am automatic sealing pistol is used to connect the c-shaped fastener and the plastic insulating panel to the already existing cement wall. FIG. 4 depicts the hole in which the nail of the automatic sealing pistol will go threw (9) and attach the fastener and the insulating panel to the cement wall.

Details of the plastic insulating panel are better seen in FIG. 5 and are preferably made of expanded polystyrene. The insulating panel is preferably 3-4 inches in thickness, while the side of the vertical channel (18) will preferably have a thickness of 2 inches. The width of face 17 according to FIG. 5, will be that of the thickness of the stud of the interior framework. Generally studs or beams that compose an interior framework have a width of 1.5 inches. That is the width of the vertical channel shown in FIG. 5. However, the width of the channel may vary depending of the width of the stud or beam that will be used for the interior framework of the interior living space. The vertical channels of the plastic insulating panels provide stability and a snug area to install the fasteners and studs of the interior framework. The c-shaped vertical channel is designed so to accommodate the fastener as well as the studs and beams of the interior framework.

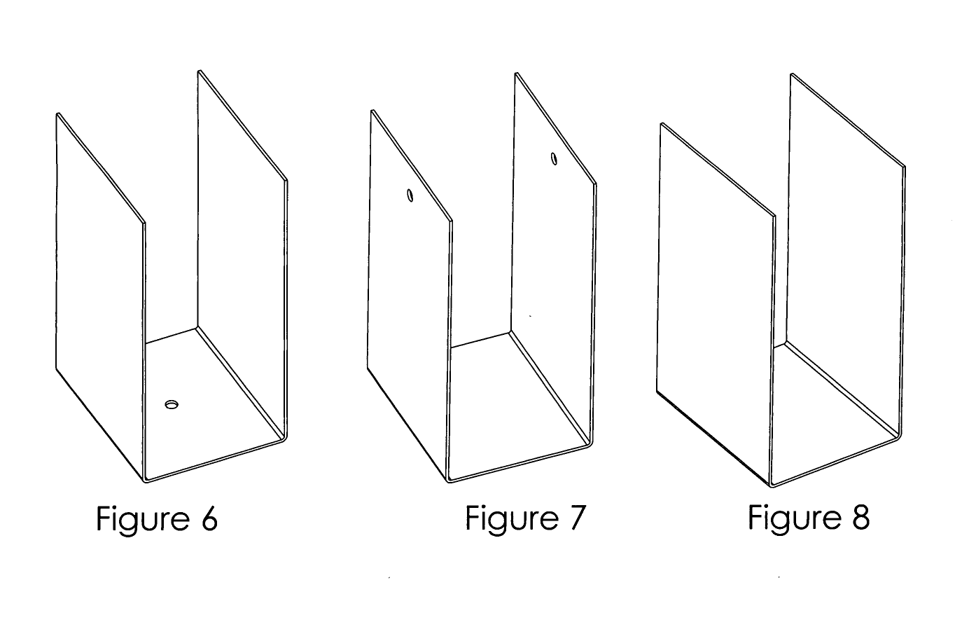

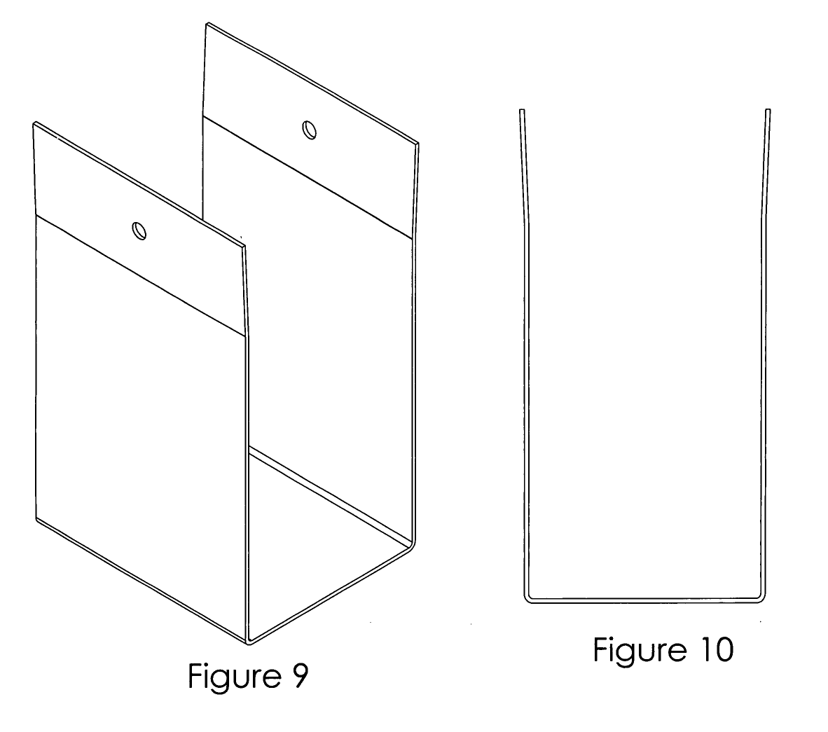

As can be seen by FIGS. 1 and 2, the studs fit perfectly into the vertical channels of the plastic insulating panels. Each stud has an interior face 10, a left face (not depicted), a right face 11, and an exterior face 13. The exterior face of the stud (FIGS. 1-13) rests tightly against the interior face of the c-shaped fastener (FIGS. 3-5). Once the studs or beams of the interior framework are placed within the vertical channels of the plastic insulating panels, screws are used to fix in place the studs to the c-shaped fasteners. The c-shaped fastener, is comprised of screw holes that go threw the sides flanges of the fastener. These screw holes are apparent in (FIGS. 3-7 and 3-8). This characteristic of the fastener is necessary to allow and maintain a firm connection between the stud of the interior framework and the fastener itself.

Details of the fastener are better seen in FIGS. 3 and 4. These metal fasteners are preferably made of metal so as to accommodate the impact force induced by the automatic sealing pistol. However, other materials may be used so as long as to accommodate the impact force induced by the automatic sealing pistol. The width of the interior/exterior face of the fastener (FIGS. 3-5 and 3-6), will be so as to accommodate the width of the interior face of the vertical channels (FIGS. 5-17), as described in the previous paragraphs. As discussed earlier, the width of the interior face of the vertical channel is generally 1.5 inches, thus making the interior/exterior face of the fastener also 1.5 inches. However, if the width of the interior face of the vertical channel of the plastic insulating panel be different than 1.5 inches, the interior/exterior face of the c-shaped fastener must accommodate for those changes. The length of the side face of the c-shaped fastener (FIGS. 3-1) is generally slightly shorter than the side face of the stud of the interior framework (FIGS. 2A-11), so as to not interfere with the installation of the interior wall of the living space. It is probable to see the studs or beams of the interior framework to have a side face length of 3.5 inches. Consequently the side face of the c-shaped fastener will be slightly shorter than 3.5 inches. However, the length of the side face of the c-shaped fastener will be designed to accommodate the length of the side face of the stud or beam that composes the interior framework.

The present invention is not limited to the embodiment disclosed and the right is reserved to make variations and modifications in the invention that do not depart from the spirit of scope thereof as herein defined by the appended claims.

The embodiments of the invention, on the subject of which exclusive rights of property or privileges are claimed and are defined as follows:

1. A building wall construction comprising of:
(a) A cement wall;
(b) A layer of plastic insulating boards formed of a plurality of evenly spaced vertical channels adjacent to the interior face of said cement wall;
(c) A plurality of c-shaped fasteners adjacent to the interior face of the said vertical channels, and;
(d) An interior framework formed of a plurality of evenly spaced studs or beams adjacent to the interior face of the said c-shaped fasteners.

2. A building wall construction according to claim 1 wherein the cement wall already exists.

3. A building wall construction according to claim 1 wherein plastic insulating boards are in the shape of panels having a minimum thickness of 1 inch.

4. A plastic insulating board according to claims 1 and 3 comprising of a plurality of evenly spaced vertical channels having a thickness of 2 inches.

5. A plastic insulating board according to claims 1, 3 and 4 wherein the said vertical channels have a width equal to that of the said studs or beams composing the interior framework.

6. A plastic insulating board according to claims 1, 3, 4 and 5 wherein the plastic insulating boards are slotted together within the L-shaped edges of the said plastic insulating board.

7. A plastic insulating board according to claims 1, 3, 4, 5 and 6 wherein the plastic insulating boards are made from expanded polystyrene.

8. A building wall construction according to claim 1 wherein the c-shaped fastener is capable of withstanding the connecting force used to connect the c-shaped fastener and the plastic insulating board to the already existing cement wall.

9. A c-shaped fastener according to claims 1 and 8 wherein the c-shaped fastener is composed of a thin metallic material.

10. A c-shaped fastener according to claims 1 and 8 wherein the c-shaped fastener is composed of a thin plastic material.

11. A c-shaped fastener according to claims 1, 8, and 10 wherein the c-shaped fastener will tightly fit inside the said vertical channels of the said plastic insulating boards.

12. A c-shaped fastener according to claims 1, 8, 9, 10 and 11 wherein the side faces of the said c-shaped fastener will be longer than that of the thickness of the said vertical channels of the said plastic insulating board.

13. A c-shaped fastener according to claims 1, 8, 9, 10, 11 and 12 wherein the c-shaped fastener is comprised of a screw hole in the face that is adjacent the interior face of the said vertical channel of the said plastic insulating board.

14. A c-shaped fastener according to claims 1, 8, 9, 10, 11, 12 and 13 wherein the c-shaped fastener is comprised of screw holes threw the side faces used to screw the said studs or beams of said interior framework to the c-shaped fastener.

15. A building wall construction according to claim 1 where the interior framework comprises of wooden or metal studs or beams.

16. An interior framework according to claims 1 and 15 where the said studs or beams are evenly spaced and placed inside the said vertical channels of said plastic insulating boards

17. An interior framework according to claims 1, 15 and 16 where the said studs or beams are connected to the said c-shaped fastener via screws that pass threw the side faces of the said studs or beams and the flanges of the said c-shaped fastener.
